(19) United States
(12) Patent Application Publication
(10) Pub. No.: US 2004/0046052 A1
(43) Pub. Date: Mar. 11, 2004

(54) Spray atomiser

(76) Inventor: Shih-Kuo Chang, Tainan (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/237,960

(22) Filed: Sep. 10, 2002

(51) Int. Cl. B05B 9/04

(52) U.S. Cl. 239/373

(57) ABSTRACT

A structure of spray atomizer is composed of a container, an inner tube, a pumping rod and a handle. The container is composed of an upper cylinder and a lower cylinder threaded to each other. The pumping rod and the handle are locked to each other by means of mortises and tenons to facilitate breakdown for storage or to save packaging volume.

### BACKGROUND OF THE INVENTION

(a) Field of the Invention

The present invention relates to a structure of a spray atomizer, and more particularly to one that has its handle to the pumping rod detachable from the pumping rod, and that has the container composed of an upper and a lower cylinders also detachable from each other to facilitate breakdown for storage or save packaging volume.

(b) Description of the Prior Art

Whereas in the application field of spray atomizer for agricultural purpose, there is one operating by manual compression as illustrated in FIGS. 5 and 6 of the accompanying drawings. The atomizer essentially comprises an integrated container (A), an inner tube (B), a guard ring (C), and a pumping rod (D). As illustrated in FIG. 7, two threaded holes (A1, A2) are respectively provided on both shoulders of the container (A) that are connected through the container (A) to a guide of an atomizing rod, and to engage each a release plug. Female thread (A3) is provided on the inner periphery in the neck of the container (A) while male thread (B1) is formed at upper end externally to the inner tube (B). The inner tube (B) is placed into the container (A) and engaged with its male thread (B1) to the female thread (A3) on the inner periphery in the neck of the container (A). Two units of mortise (B3) and tenon (B2) are alternatively and symmetrically provided on the top flange of the inner tube (B); and a one-way valve (B4) is disposed at the bottom in the hollow inner tube (B). The guard ring (C) composed of two semi-circular pieces corresponding to the body (D1) of the pumping rod (D) to be described later is provided to the top flange of the inner tube (B) in a configuration that the body (D1) of the pumping rod (D) is inserted into the inner tube (B) through the guard ring (C). An insertion hole (C1) is provided on the guard ring (C) to be inserted by its corresponding tenon (B2) for the guard ring (1) to be fixed to the top flange of the inner tube (B); and a trough (C2) also provided on the guard ring (C) is coupled by the mortise (B3) while the body (D1) of the pumping rod (D) retained by the guard ring (1) is inserted into the inner tube (B). A piston (D2) disposed at the lower end of the body (D1) of the pumping rod (D) inserting into the inner tube (B) holds against the inner wall of the inner tube (B) while a positioning piece (D3) disposed at the other end of the body (D1) of the pumping rod (D) exposed from the inner tube (B) is formed in one piece with a handle (D4). When the spray atomizer is not in use, the positioning piece (D3) is pushed forward into where between two mortises (B3), then turned for 90 degrees so that both ends of positioning piece (D3) is locked in the inner concave area at where both of said mortises (B3) are facing to each other. As a result, the pumping rod (D) is fixed in position and fully inserting in the inner tube (B) to prevent the pumping rod (D) from being freely pulled up; thus the user may easily carry the entire spray atomizer by the handle (D4) for movement or storage. Furthermore, in the use of the spray atomizer as illustrated in FIG. 7, by reciprocal pulling and pushing the handle (D4) of the pumping rod (D), ambient air for compression is introduced from the top of the inner tube (B) as the piston (D2) at the inner end of the pumping rod (D) is pulled all way up to the top of the inner tube (B) then glides down all the way along the inner wall of the inner tube (B); the air is then pumped into the container (A) in one way by means of the one-way valve (B4) at the bottom inside the inner tube (B). The air pressure is mounting up as the air is only admitted in without being pumped out to create the pressure required to pump out the pesticide solution in the container (A).

However, the spray atomizer of the prior art is manufactured and sold with all components separately packed and the consumer has to assemble at own efforts before the use. In terms of the structure of the pumping rod alone, it is comparatively long and wider as the handle is concerned since both of the handle and the pumping rod are integrated in one piece. As a result, the packaging of the handle and the pumping rod indicating a T-shaped to consume a significant volume of the entire unit of the spray atomizer while nearly half of the packaging space may be otherwise saved. Even with the pumping rod is connected to the container of the spray atomizer; the vertically disposed handle at the top of the container also consumes too much space of storage. Furthermore, the replacement of spares is also very expensive as the container is integrated in one piece, it also consumes too much space; and the pumping rod also being formed integrated with the handle, any damage to a certain part will need to replace the whole pumping rod.

### SUMMARY OF THE INVENTION

The primary purpose of the present invention is to provide an improved structure of a spray atomizer that is capable of reducing the shipping volume, thus the reduced shipping cost. To achieve the purpose, the present invention is composed of a container, an inner tube, a pumping rod and a handle. Wherein, the pumping rod and the handle are detachable from each other while the container is made into two pieces to facilitate breakdown for storage and to save shipping space by reducing protrusion part, characterized by that:

the container is made into two pieces, the upper cylinder and the lower cylinder threaded to each other by threads; threads are also provided at where the body of the pumping rod is connected to the bottom of the handle by a locking mechanism so that the pumping rod may be engaged with or separated from the handle when the use of the spray atomizer or the storage or shipping is required as the case may be.

### BRIEF DESCRIPTION OF THE DRAWINGS

FIG. 1 is an exploded view of the present invention.

FIG. 1A is en enlarged view of a locking seat of the present invention.

FIG. 2 is a cross-sectional view showing an assembly of the present invention.

FIG. 2A is a partially enlarged view of FIG. 2.

FIG. 3 is a perspective view of a first preferred embodiment of the present invention.

FIG. 4 is a perspective view of a second preferred embodiment of the present invention.

FIG. 5 is an exploded view showing a structure of a spray atomizer of a prior art.

FIG. 6 is a perspective showing an assembly of the spray atomizer of the prior art.

FIG. 7 is a cross-sectional view showing a reference status of use of the spray atomizer of the prior art.

### DETAILED DESCRIPTION OF THE PREFERRED EMBODIMENTS

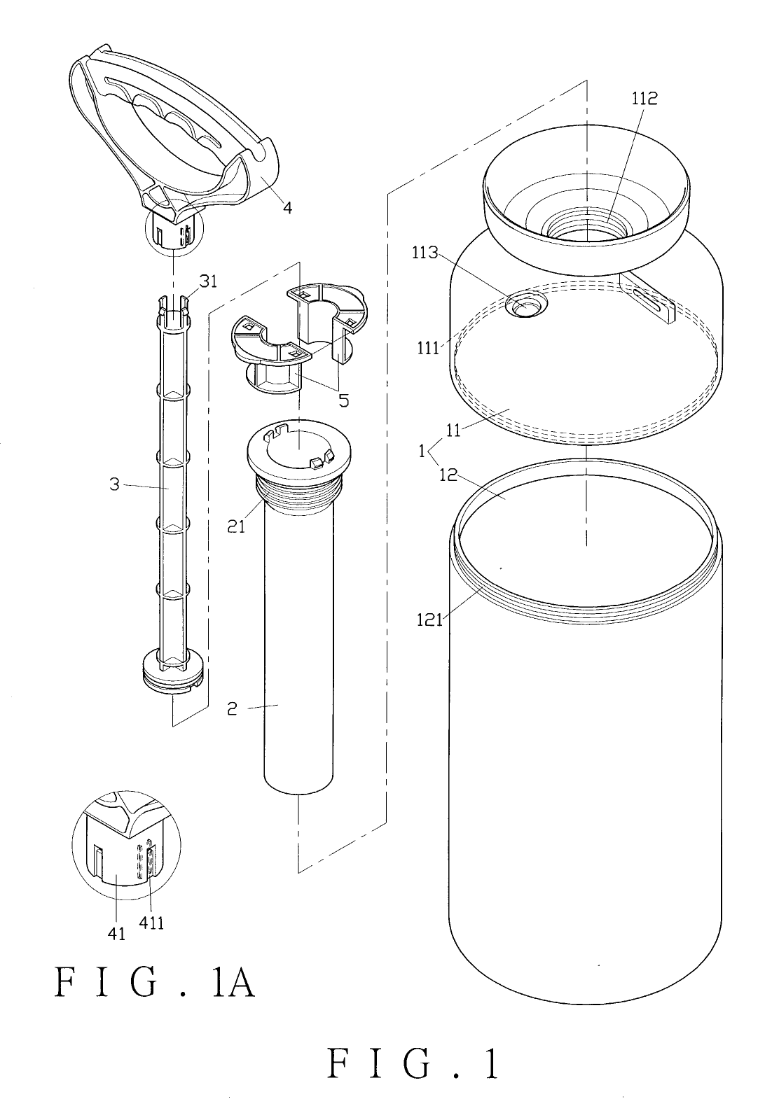

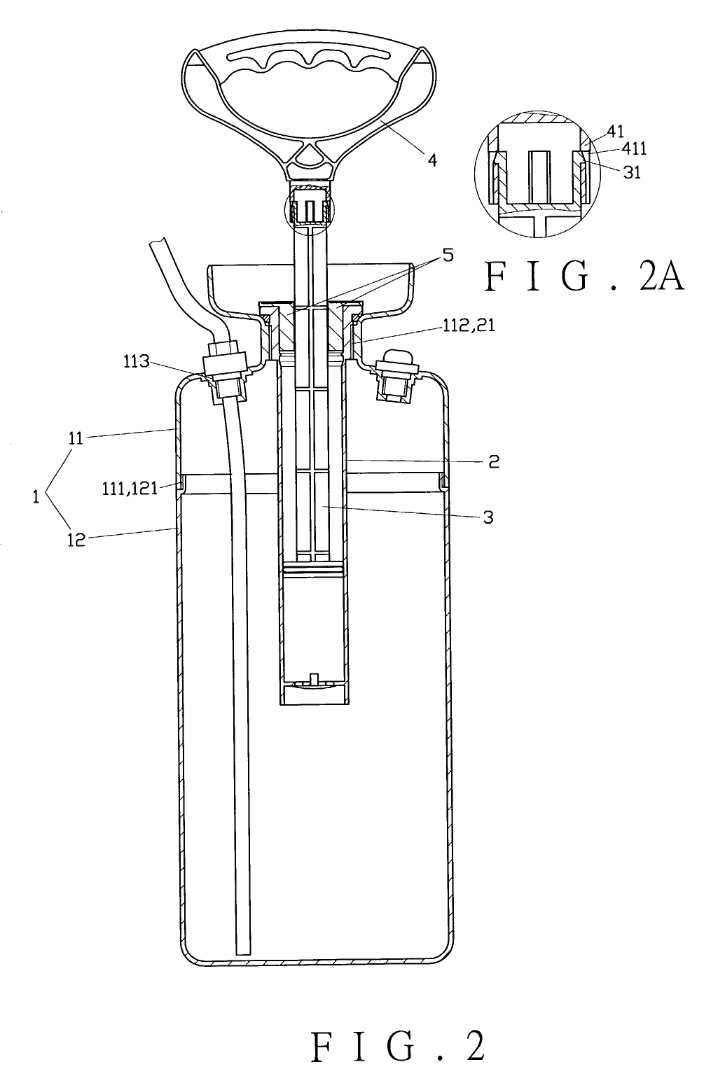

Referring to FIG. 1, the present invention essentially comprises a container (1), an inner tube (2), a pumping rod (3) and a handle (4).

The container (1) is composed of two pieces, an upper cylinder (11) and a lower cylinder (12). Threaded sections (111, 121) are respectively provided at where both of the upper and the lower cylinders (11, 12) are connected to each other into one piece. An inner thread (112) is axially provided at the opening of the upper cylinder (11) to be engaged by the inner tube (2). A threaded hole (113) is provided on the shoulder of the upper cylinder (2) to be connected to a spray gun (not illustrated).

The inner tube (2) is a hollow tube having its outer periphery provided with outer thread (21) to be engaged to the container (1) while the pumping rod (3) inserts into the inner tube (2) and two semi-circular guard rings (5) are fixed at the outlet of the inner tube (2) to restrict the pumping rod (3) from accidental fall out of the inner tube (2) while the pumping rod (3) is reciprocally pulled and pushed inside the inner tube (2).

The pumping rod (3) has its upper end bolted to and becomes integrated with the handle (4) by a locking structure, wherein, a locking seat (41) is formed at the bottom of the handle (4) and a plurality of mortises (411) are disposed on the periphery of the locking seat (41), while a plurality of tenons (31) to be interlocked with the mortises (411) of the handle (4) are extended from the pumping rod (3) at where in relation to the connection to the handle (4), or a plurality of mortises can be provided at the end of the pumping rod with a plurality of corresponding tenons formed to the handle for both of the pumping rod (3) and the handle (4) to be intimately locked to each other.

The handle (4) having the locking seat (41) first extends in relation to one end of the pumping rod so to merely have the tenon (311) to be locked in the mortise (411) of the locking seat (41) for both of the handle (4) and the pumping rod (3) to become one piece. The pumping rod (3) integrated with the handle (4) is placed into the inner tube (2) and held in position by the guard rings (5) to avoid accidental fall of the pumping rod (3) out of the inner tube (2). Then both of the upper and the lower cylinders (11, 12) are connected to each other to form the container (1) then the inner tube (2) inserted with the pumping rod (3) has the outer thread (21) to engage to the inner thread (112) at the opening of the container (1). In practice, air is pumped in by the pumping rod (3) in relation to the inner tube (2) so to only admit the air entering into the container (1) for creating a high pressure status inside the container (1) to pump out pesticide solution inside the container (1) to the spray gun.

In the packaging for shipment, the upper cylinder and the lower cylinder (11, 12) of the container (1), the inner tube (2), the pumping rod (3) and the handle (4) can be removed for significant saving of shipping space, thus for reduction of shipping cost.

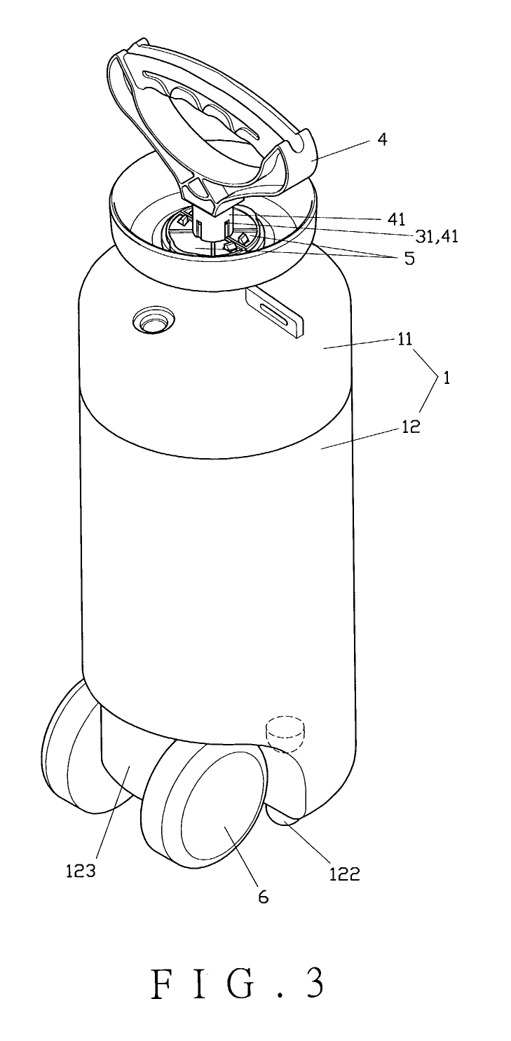

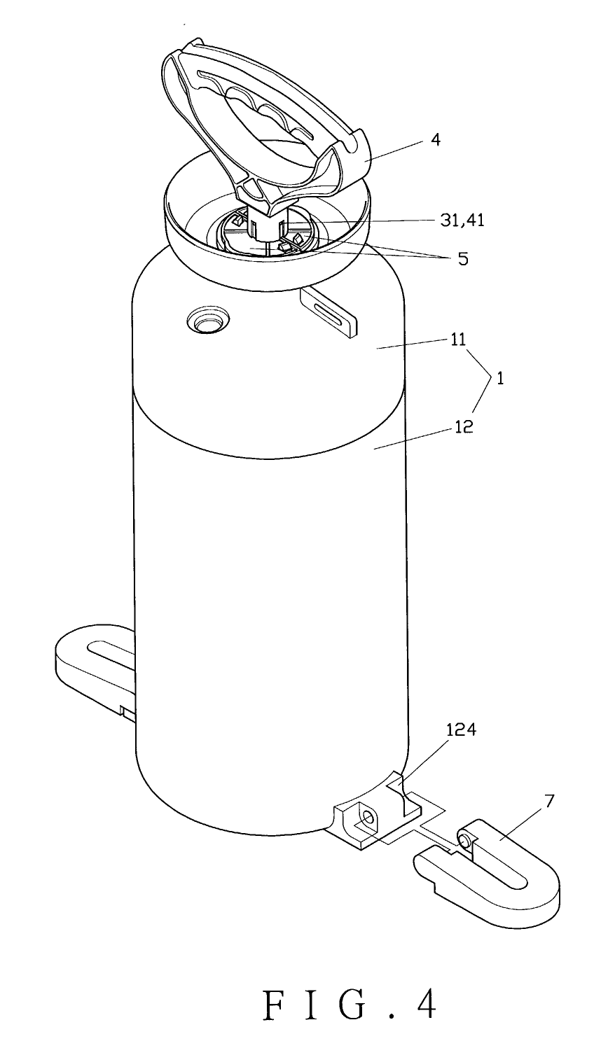

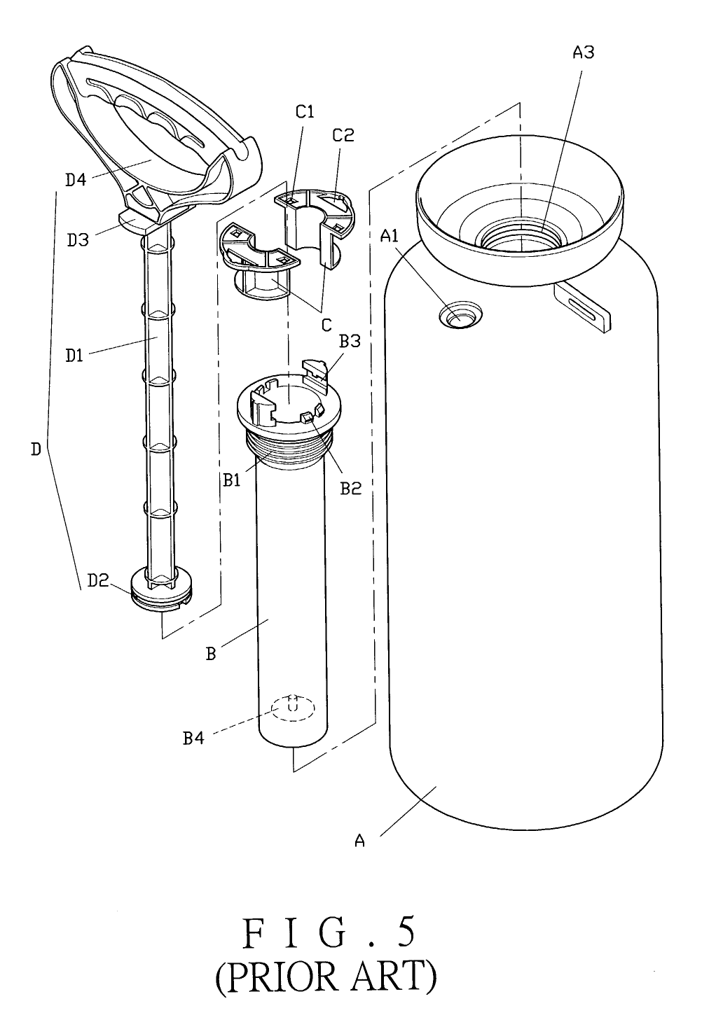

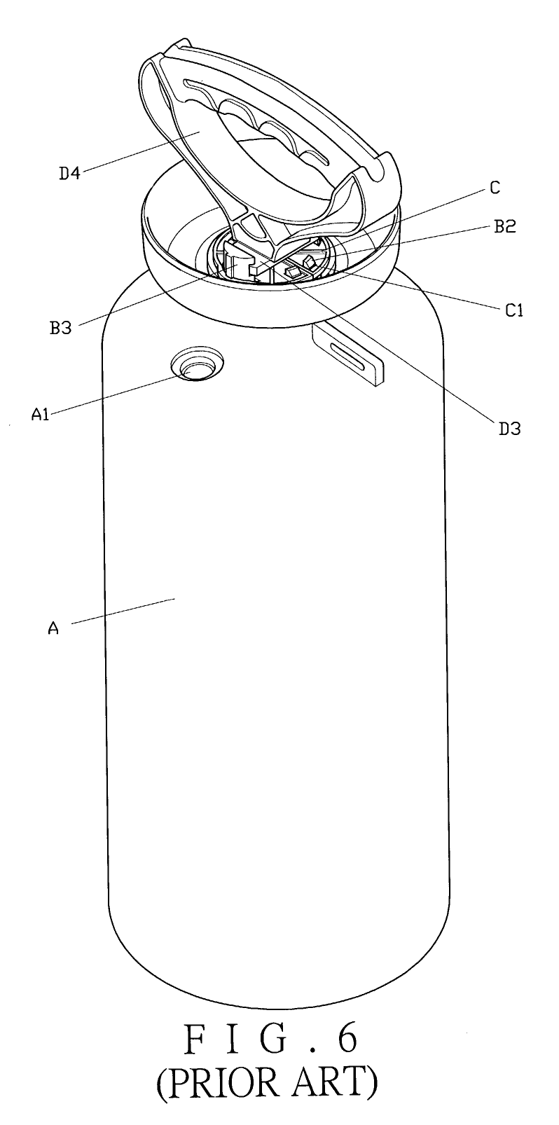

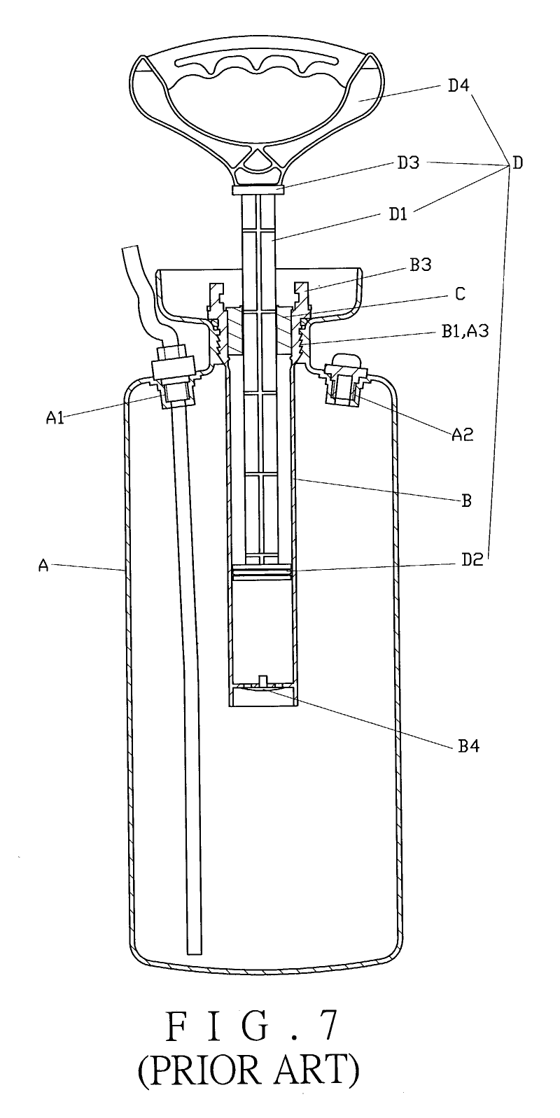

Now referring to FIG. 3, wherein, a plurality of positioning walls (122) at the bottom of the lower cylinder (12) and an independent pivoting wall (123) is formed at the bottom of the lower cylinder (12) to be pivoted to two wheels (6) so to help firm standing of the container (1) to provide mobility to tow the container (1) at a certain slant. Alternatively, as illustrated in FIG. 4, two pivoting seats (124) are respectively provided on the bottom edge of the opposite sides of the lower cylinder (12) to be pivoted to a stand (7) to help firm standing of the container (1).

As disclosed, an improved structure of a spray atomizer comprises detachable members to achieve purpose of reduced packaging volume and materials.

I claim,

1. A structure of a spray atomizer comprising a container, an inner tube and a pumping rod; wherein, said container being a hollow cylinder allowing said inner tube to axially insert inside said container; said pumping rod being penetrated into said inner tube to pump air and having one end exposed from said inner tube provided with a handle; a locking structure being provided at said pumping rod being engaged to the bottom of said handle; both of said pumping rod and said handle being detachable from each other to facilitate breakdown for storage and save packaging space.

2. The structure of a spray atomizer as claimed in claim 1, wherein, said pumping rod is engaged to said handle by a locking structure composed of a plurality of mortises and tenons respectively provided on the top end of said pumping rod and the bottom of said handle.

3. The structure of a spray atomizer as claimed in claim 1, wherein, a plurality of positioning walls are formed at the bottom of said container and a pivoting wall is formed at the bottom of said container to be pivoted to a pair of wheels to help firm standing of and mobility of towing for said container.

4. The structure of a spray atomizer as claimed in claim 1, wherein, a pivoting seat pivoted to a stand is each provided at a bottom edge on two opposite sides of said container.

5. A structure of a spray atomizer comprising a container, an inner tube and a pumping rod, wherein, said container is a hollow cylinder to allow said inner tube axially inserting inside said inner tube; said inner tube being penetrated through by said pumping rod to pump air inside said inner tube characterized by that:
said container being composed of an upper cylinder and a lower cylinder threaded to each other.

6. The structure of a spray atomizer as claimed in claim 5, wherein, a plurality of positioning walls are formed at the bottom of said lower cylinder and a pivoting wall is formed at the bottom of said the lower cylinder to be pivoted to a pair of wheels to help firm standing of and mobility of towing for said container.

7. The structure of a spray atomizer as claimed in claim 5, wherein, a pivoting seat pivoted to a stand is each provided at a bottom edge on two opposite sides of said lower cylinder.
